(19) United States
(12) Patent Application Publication
(10) Pub. No.: US 2015/0032918 A1
(43) Pub. Date: Jan. 29, 2015

(54) MULTIPLE-FORMAT MULTIMEDIA INTERFACE MODULE

(71) Applicant: ALGOLTEK, INC., Zhubei City (TW)

(72) Inventors: Dalee ZHANG, Hsinchu (TW); Sheng-Chieh CHAN, Hsinchu (TW); Shih-Min LAN, Hsinchu (TW)

(73) Assignee: ALGOLTEK, INC.

(21) Appl. No.: 14/334,967

(22) Filed: Jul. 18, 2014

(30) Foreign Application Priority Data
Jul. 29, 2013 (TW) TW102127179

(51) Int. Cl. G06F 13/10

(52) U.S. Cl. CPC G06F 13/102
USPC 710/62

(57) ABSTRACT

The present invention is a multiple-format multimedia interface module, comprising a first port, a circuit module, a first transmission line, a second port, and a second transmission line. The multiple-format multimedia interface module connects a mobile device with a display device conveniently, and may bidirectionally transmit signals between a transmitter end with multiple signal formats of MHL, MyDP, and USB and a receiver end with a single signal format of HDMI or bidirectionally transmit signals between a transmitter end with a single signal format and a receiver end with multiple signal formats.

### BACKGROUND OF THE INVENTION

1. Technical Field

The invention relates to a multimedia interface module, and more particularly, to a multiple-format multimedia interface module that may connect a mobile device with a display device.

2. Description of Related Art

Due to the popularization of mobile devices in recent years, the needs for watching or saving multimedia on mobile devices have substantially increased. Formats of multimedia presently used on mobile devices mainly include Mobile High-Definition Link (MHL) and Mobility DisplayPort (MyDP), and Micro-USB ports are usually employed as the interface port.

On the other hand, the development of liquid crystal display technologies has also largely reduced the prices of display devices, and the applications and demands have also increased, However, most multimedia interfaces of display devices of the present day use the 19-pin High-Definition Multimedia Interface (HDMI) format and HDMI port. If multimedia is to be bidirectionally transmitted between a mobile device and a display device, issues of signal format incompatibilities may occur.

In order to facilitate the bidirectional transmission of MHL, MyDP, or USB signals with different formats with HDMI signals, a multiple-format multimedia interface module that may utilize present mobile device ports and display device ports and is cost effective, light, and convenient is seriously required.

### SUMMARY OF THE INVENTION

The present invention is a multiple-format multimedia interface module, comprising a first port, a circuit module, a first transmission line, a second port, and a second transmission line. The multiple-format multimedia interface module connects a mobile device with a display device conveniently, and may bidirectionally transmit signals between a transmitter end with multiple signal formats and a receiver end with a single signal format or between a transmitter end with a single signal format and a receiver end with multiple signal formats.

The invention provides a multiple-format multimedia interface module, comprising: a first port, which is a Micro-USB port, bidirectionally transmitting a first signal, wherein the first signal is a Mobile High-Definition Link (MHL) signal, Mobility DisplayPort (MyDP) signal, or Universal Serial Bus (USB) signal; a circuit module, converting the first signal into a second signal or converting the second signal into the first signal, wherein the second signal is a High-Definition Multimedia Interface (HDMI) signal; a first transmission line, connecting the first port and the circuit module; a second port, which is a HDMI port, bidirectionally transmitting the second signal; and a second transmission line, connecting the circuit module and the second port.

Implementation of the present invention at least involves the following inventive steps:

(1) present mobile device ports and display device ports may be used without requiring extra equipment or cost;

(2) transmissions between a transmitter end with multiple signal formats and a receiver end with a single signal format or between a transmitter end with a single signal format and a receiver end with multiple signal formats may be implemented; and

(3) achieves multiple-format multimedia transmission that is cost effective, light, and convenient.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic of a multiple-format multimedia interface module according to an embodiment of the invention;

FIG. 2 is a schematic of the signal transmission of the multiple-format multimedia interface module according to an embodiment of the invention;

FIG. 3 is a schematic of a multiple-format multimedia interface module according to another embodiment of the invention; and

FIG. 4 is a schematic of a multiple-format multimedia interface module according to still another embodiment of the invention.

### DETAILED DESCRIPTION OF THE EMBODIMENTS OF THE INVENTION

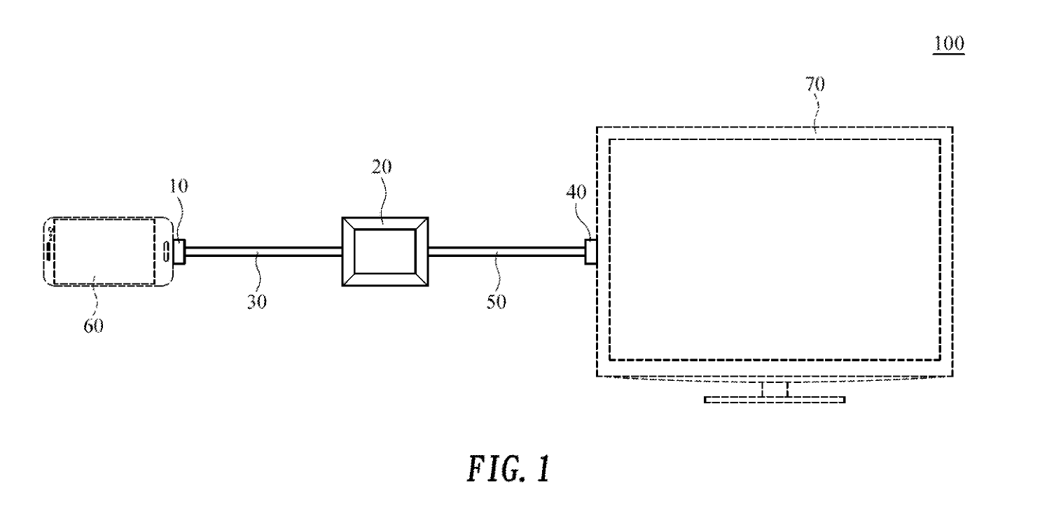

FIG. 1 shows an embodiment of the multiple-format multimedia interface module 100, comprising: a first port 10, a circuit module 20, a first transmission line 30, a second port 40, and a second transmission line 50. The circuit module 20 is connected to the first port 10 and the second port 40 via the first transmission line 30 and the second transmission line 50, respectively, and the first port 10 and the second port 40 are connected to the mobile device 60 and the display device 70, respectively.

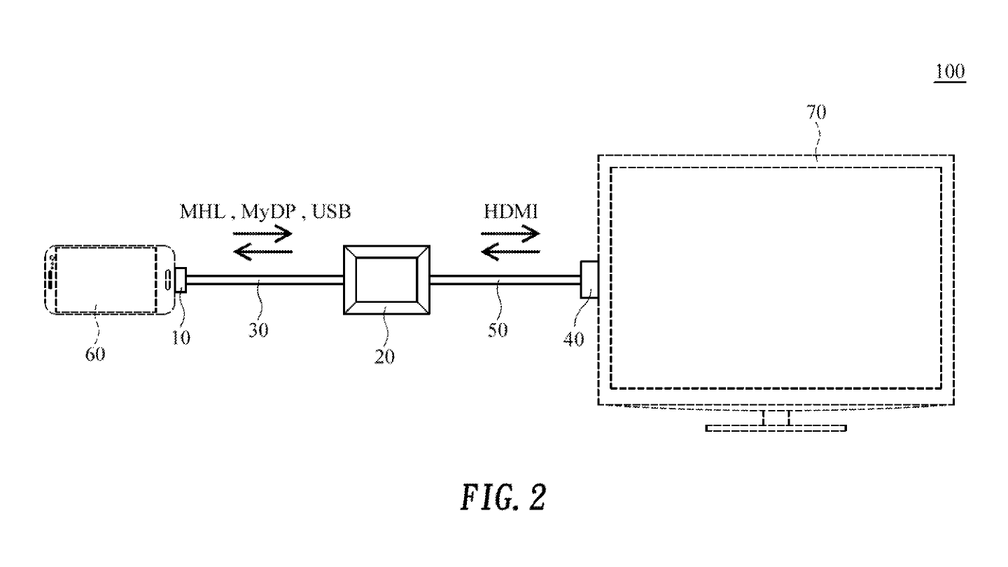

As shown in FIG. 1 and FIG. 2, the first port 10 may be a Micro-USB port, and the first port 10 may be electrically connected to the mobile device 60 to bidirectionally transmit a first signal, wherein the first signal may be a MHL signal, MyDP signal, or USB signal. In other words, the first port 10 in FIG. 1 may allow multimedia signals of multiple formats to be bidirectionally transmitted via a Micro-USB port.

FIG. 2 shows a schematic of the embodiment of the bidirectional transmission of a MHL signal, MyDP signal, or USB signal via the first port 10.

As shown in FIG. 1 and FIG. 2, the circuit module 20 converts the first signal into a second signal or converts the second signal into the first signal, wherein the second signal is a HDMI signal. That is to say, the circuit module 20 converts between the signal formats of the MHL signal, MyDP signal, or USB signal and the HDMI signal.

As also shown in FIG. 1 and FIG. 2, the first transmission line 30 connects the first port 10 and the circuit module 20; the mobile device 60 transmits the MHL signal, MyDP signal, or USB signal to the circuit module 20 via the first port 10 and the first transmission line 30, or receives the MHL signal, MyDP signal, or USB signal from the circuit module 20.

As shown in FIG. 1 and FIG. 2, the second port 40 may be a HDMI port that bidirectionally transmits the second signal. The second port 40 is connected with the display device 70 and inputs the HDMI signal to the display device 70 or outputs the HDMI signal from the display device 70.

As also shown in FIG. 1 and FIG. 2, the second transmission line 50 connects the circuit module 20 and the second port 40. In other words, the second transmission line 50 and the second port 40 connect the circuit module 20 with the display device 70 and bidirectionally transmits the HDMI signal between the circuit module 20 and the display device 70.

By the embodiment of the multiple-format multimedia interface module 100 shown in FIG. 1 and FIG. 2, the mobile device 60 may transmit multimedia signals of multiple formats to a display device 70 with a port of a single format, and the display device 70 with a port of a single format may also transmit multimedia to the mobile device with a port of multiple signal formats. In other words, the multiple-format multimedia interface module 100 of the embodiment may bidirectionally transmit signals between a transmitter end with multiple signal formats and a receiver end with a single signal format, and may bidirectionally transmit signals between a transmitter end with a single signal format and a receiver end with multiple signal formats.

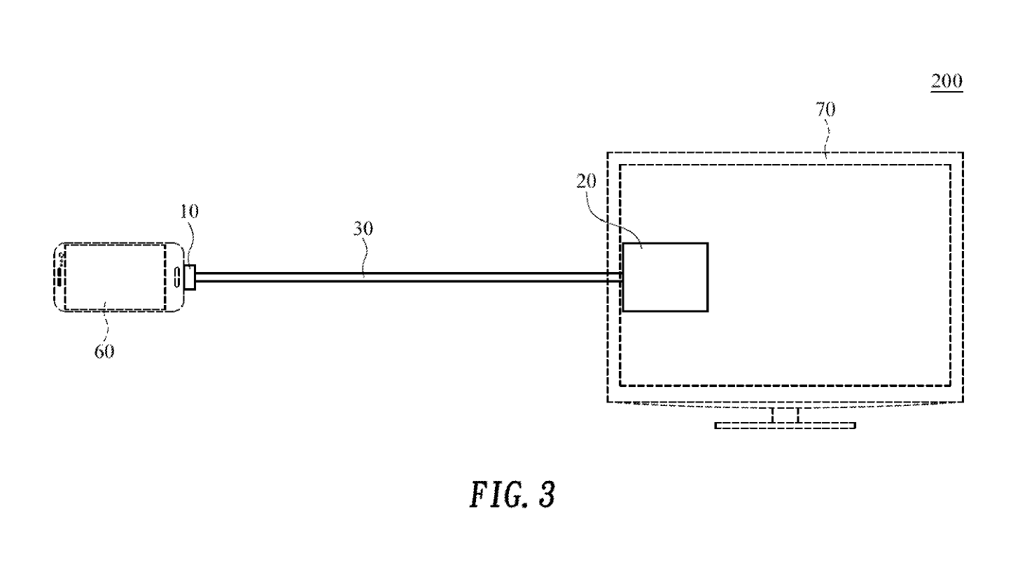

FIG. 3 shows another embodiment of the multiple-format multimedia interface module 200, wherein the circuit module 20 is fixed within and electrically connected to the display device 70. By the connection of the multiple-format multimedia interface module 200 shown in FIG. 3, the display device 70 may be electrically connected with the mobile device 60 via the first transmission line 30 and the first port 10 only, which simplifies the manufacture, storage, or usage of connectors.

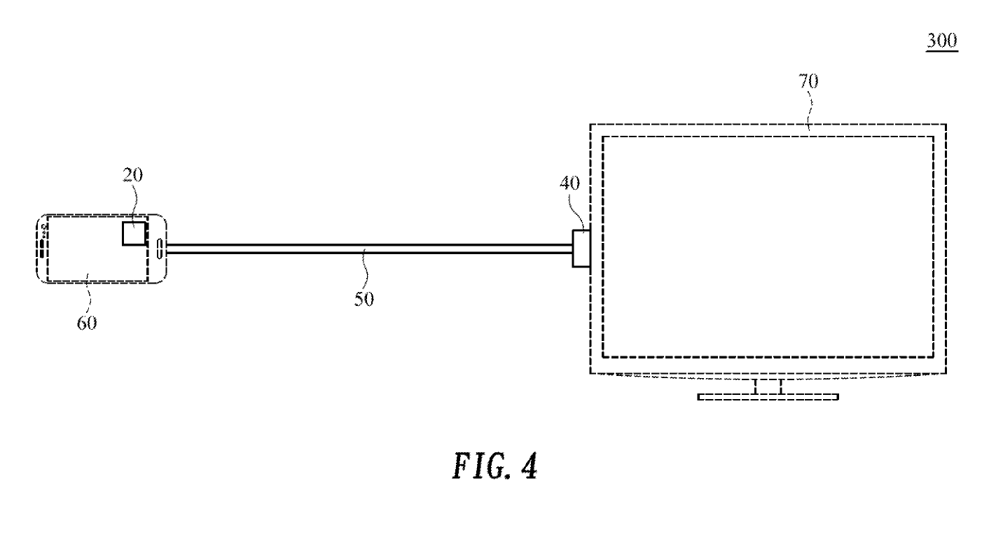

FIG. 4 shows still another embodiment of the multiple-format multimedia interface module 300, wherein the circuit module 20 is fixed within and electrically connected to the mobile device 60. By the connection of the multiple-format multimedia interface module 300 shown in FIG. 4, the mobile device 60 may be electrically connected with the display device 70 via the second transmission line 50 and the second port 40 only, which also simplifies the manufacture, storage, or usage of connectors.

For the multiple-format multimedia interface modules 100, 200, or 300 shown in FIG. 1 to FIG. 4, the display device 70 may be a television, monitor, or projector device with a HDMI port in actual applications.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A multiple-format multimedia interface module, comprising:
a first port, which is a Micro-USB port, bidirectionally transmitting a first signal, wherein the first signal is a Mobile High-Definition Link (MHL) signal, Mobility DisplayPort (MyDP) signal, or Universal Serial Bus (USB) signal;
a circuit module, converting the first signal into a second signal or converting the second signal into the first signal, wherein the second signal is a High-Definition Multimedia Interface (HDMI) signal;
a first transmission line, connecting the first port and the circuit module;
a second port, which is a HDMI port, bidirectionally transmitting the second signal; and
a second transmission line, connecting the circuit module and the second port.

2. The multiple-format multimedia interface module as claimed in claim 1, wherein the first port is electrically connected with a mobile device and the second port is electrically connected with a display device.

3. The multiple-format multimedia interface module as claimed in claim 2, wherein the circuit module is fixed within and electrically connected to the display device, and wherein the display device is electrically connected with the mobile device via the first transmission line and the first port.

4. The multiple-format multimedia interface module as claimed in claim 2, wherein the circuit module is fixed within and electrically connected to the mobile device, and wherein the mobile device is electrically connected with the display device via the second transmission line and the second port.

5. The multiple-format multimedia interface module as claimed in claim 2, wherein the display device is a television, monitor, or projector device.

6. The multiple-format multimedia interface module as claimed in claim 3, wherein the display device is a television, monitor, or projector device.

7. The multiple-format multimedia interface module as claimed in claim 4, wherein the display device is a television, monitor, or projector device.
